(19) United States
(12) Patent Application Publication
(10) Pub. No.: US 2014/0301710 A1
(43) Pub. Date: Oct. 9, 2014

(54) Method For Operating A Lighting System Integrating A Video Camera

(71) Applicant: MA LIGHTING TECHNOLOGY GMBH, Waldbuttelbrunn (DE)

(72) Inventors: Michael Adenau, Wurzburg (DE); Hartmut Cordes, Bremen (DE)

(73) Assignee: MA Lighting Technology GmbH, Waldbuttelbrunn (DE)

(21) Appl. No.: 13/856,559

(22) Filed: Apr. 4, 2013

(51) Int. Cl. H04N 5/235; H04N 5/77

(52) U.S. Cl. CPC H04N 5/2354; H04N 5/77
USPC 386/224

(57) ABSTRACT

A method for operating a lighting system includes the steps of a) illuminating a stage with light from at least one light source; b) recording a portion of the stage with the video camera and generating digital video signals; c) transmitting the digital video signals to a video conversion device; d) converting the video signals into digital image data signals; e) transmitting the digital image data signals to the digital memory of the lighting control console; f) starting a display task in the digital processor of the lighting control console, in order to process the image data signals for displaying the same at the display of the lighting control console; and g) graphically representing a portion of the stage by displaying the image data signals which have been processed in the digital processor at the display of the lighting control console.

### STATEMENT REGARDING FEDERALLY SPONSORED RESEARCH OR DEVELOPMENT

Not applicable.

### FIELD OF THE INVENTION

The invention relates to a method for operating a lighting system integrating a video camera.

### BACKGROUND OF THE INVENTION

For instance, but by no means exclusively, known lighting systems are used for lighting concert, theater and television stages. Said lighting systems comprise lighting control consoles for controlling the lighting systems. Within the lighting control console, a digital processor and a digital memory are provided in order to enable digital signal processing. As a matter of course, multiple digital processors and multiple digital memories can be provided as well. By means of the lighting control console, control data are generated, managed and stored in order to control the various light sources of the lighting system. The lighting control consoles comprised by known lighting systems can control up to several thousand different light sources and can create a predetermined lighting scenario under program control.

Furthermore, the lighting system comprises at least one video camera with which the stage can be recorded and a digital video signal can be generated. The video camera makes it possible to observe the proceedings on the stage in an electronic manner. With known lighting systems, the video signals of the video camera are redistributed via a separate video signal data network and are displayed at displays which are suitable for processing the digital video signals. This type of electronic representation of the proceedings on the stage has great disadvantages. This is because in the control center of the lighting system, in which the lighting control console is established, besides the lighting control console, a separate video system with displays for displaying the video signals of the video cameras has to be installed. This coexistence of the lighting control system having the lighting control console and the light sources connected thereto and the video system having the video camera and the video display suitable for displaying the video signals requires a high installation effort. Furthermore, the image information contained in the video signals cannot be taken into account by the lighting control console.

### SUMMARY OF THE INVENTION

Starting from this state of the art, it is therefore the object of the present invention to provide a new method for operating a lighting system cooperating with a video camera, which eliminates the disadvantages of the known state of the art. This object is attained by a method according to the teachings described herein.

With the method according to one embodiment of the invention, a part of the stage is illuminated with light from at least one light source of the lighting system and a portion of the stage is recorded with the video camera. The video images recorded by the video camera are converted into digital video signals.

Now, instead of transmitting the digital video signals to a video display suitable for displaying the digital video signals, it is envisaged according to the invention to initially transmit the video signals to a conversion device. Within the conversion device, the digital video signals of the video camera are converted into digital image data signals which can be processed by the digital processor of the lighting control console. Subsequently, the digital image data signals obtained in this way are transmitted to the lighting control console and are stored at least temporarily in the digital memory there.

The digital image data signals stored at least temporarily in the digital memory of the lighting control console are subsequently processed after starting a display task in the digital processor. Then, the result of this image data processing in the digital processor is image data signals which are suitable for being displayed on the display of the lighting control console. The image data signals processed in this way are subsequently displayed on the display of the lighting control console, such that the user can view the portion of the stage which has been recorded by the video camera on the display of the lighting control console.

By applying the method according to the invention, the video camera is integrated into the apparatus of the lighting system and makes it possible to display the images recorded by the video camera on the display of the lighting control console. The video display otherwise required for directly displaying the video signals from the video camera can be omitted in this way. Furthermore, integrating the video data into the data processing of the lighting control console provides a wide variety of options for controlling the lighting system.

In order to increase flexibility when operating the lighting control console, it is particularly advantageous if a stage representation window is defined when processing the image data signals in the digital processor of the lighting control console. In said stage representation window, the image data of the video camera are then displayed. Subsequently, the stage representation window can be displayed in a typical manner in a portion of the screen of the display and can be made smaller and/or moved there. In this way, the user thus has the option to adapt the display of the portion of the stage to his respective requirements by means of a corresponding manipulation of the stage representation window.

According to a first method variant, it is envisaged that the user can change the position of the stage representation window on the display by entering a corresponding user command. If, for instance, the stage representation window is displayed on a touch screen, the user can move the stage representation window on the surface of the touch screen by touching the touch screen in the area of the stage representation window and by subsequently moving his finger.

Alternatively or additionally to changing the position, according to another method variant, it can also be envisaged to change the size and/or scale of the stage representation window on the display by entering user commands. If the display is, for instance, a touch screen, the user can narrow or spread out the stage representation window on the screen by means of multitouch handling.

Integrating the image information from the video camera into the data processing of the lighting control console according to the invention makes further application variants possible. In particular, it is advantageous if an image analysis task is carried out in the digital processor of the lighting control console, in order to evaluate the image data signals with respect to the image content. Depending on the evaluation result, other options can then be controlled by the lighting control console.

According to a first option for using the results from the image analysis task, it is envisaged that at least one light source is selected by the lighting control console and that, by transmitting an actuating command, emission of a light signal is caused. Said light signal emitted by the light source is recorded with the video camera and the image data signals are analyzed after conversion in the image analysis task. By means of said analysis of the image data signals, it is possible to identify the positions of the selected light source in the image portion to be displayed. As a result, it becomes possible due to said option of the image analysis task to unambiguously identify a particular light source and its position in the image portion to be displayed.

According to a first variant of said first option of the image analysis task, it is envisaged to show the designation of the selected light source, which has been identified by the image analysis task, at the position of the selected light source in the displayed image portion. As a result, the user does not only see the image of the stage with the light source, but the designation of the light source, which is stored in the memory of the lighting control console, is also displayed. In this way, the user can immediately and unambiguously identify the light sources displayed in the image portion, whereby selecting individual light sources is substantially simplified, in particular if the display is a touch screen.

Furthermore, after identifying the position of the selected light source in the image portion to be displayed, an area of the touch screen can be defined around said position, which is unambiguously assigned to said light source during control by the user. If the user touches the touch screen area which is defined at the touch screen and is unambiguously assigned to the identified light sources, the input command subsequently entered by the user is automatically assigned to the selected light source. In this way, it is made possible to work intuitively at the lighting control console, since the user does not have to remember designations of the individual light sources anymore, but instead is able to select the light sources displayed at the touch screen of the lighting control console by simply touching the area of the light sources and is able to assign corresponding input commands.

According to a second option for applying the image analysis task, it is envisaged that the image contents are evaluated by the image analysis task and that, depending on the analysis result, at least one light source is actuated as a function of the image content. In other words, this means that actuating the light sources can automatically be triggered by means of the image analysis. If, for instance, an actor enters the stage or if there is a color change on the stage or if the brightness on the stage has changed, these events can be identified by the image analysis task and, depending on the result of the image analysis task, an actuating command can be generated. For instance, it is conceivable that a specific spotlight is automatically turned on by the lighting control console by means of the image analysis task when an actor enters the stage.

According to a variant of the second option for using the image analysis task, it is envisaged that the image camera is formed in the manner of an infrared camera. In the image analysis task, brightness changes in the infrared range can then be identified and actuating commands can be generated depending thereon. Due to this variant, it is possible to place infrared light sources on the stage and to trigger specific control commands of the lighting control console by turning them on.

Which type of video signals is converted into image data signals in the conversion device can basically be freely chosen. According to a preferred variant, it is envisaged that the video signals are emitted in the USB data format or in the SDI data format or in the VGA data format.

If the lighting control console itself is connected to a data network for the purpose of data transmission, in order to control the different light sources via said data network, it is furthermore particularly advantageous if the conversion device forms a network node of the data network for converting the video signal from the video camera into digital image data signals. In this way, the digital image data signals can be transmitted from the network node to the digital processor of the lighting control console via the data network after having been converted within the conversion device.

### BRIEF DESCRIPTION OF THE DRAWINGS

The method according to the invention is schematically illustrated by the drawings and is explained by way of example in the following.

In the drawings:

FIG. 1 shows, in a schematized top view, a stage with four light sources which can be recorded in portions by two video cameras;

FIG. 2 shows the video image of the stage recorded by the first video camera according to FIG. 1;

FIG. 3 shows the video image of the stage recorded with the second video camera according to FIG. 1;

FIG. 4 shows the schematized structure of the lighting system for illuminating the stage according to FIG. 1 integrating the two video cameras;

FIG. 5 shows the lighting control console of the lighting system according to FIG. 4 displaying the stage according to FIG. 1 at the touch screens of the lighting control console; and

FIG. 6 shows an enlarged view of the touch screen of the lighting control console according to FIG. 5.

### DETAILED DESCRIPTION OF THE EXAMPLE EMBODIMENTS

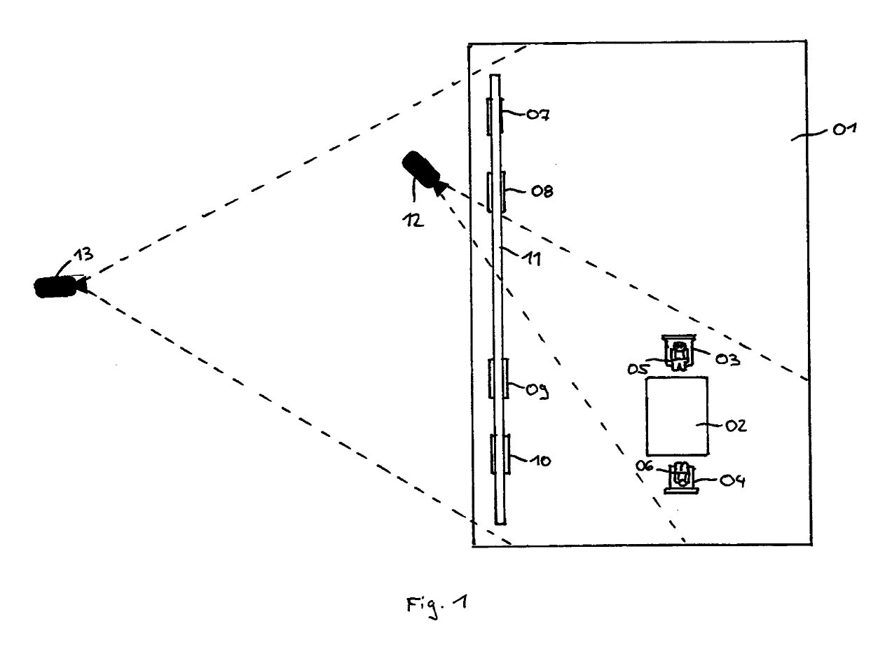

In a schematized view, FIG. 1 shows a television stage 01 with a table 02, two chairs 03 and 04 and two actors 05 and 06. The stage 01 can be illuminated by means of four light sources 07, 08, 09 and 10. The light sources 07 to 10 are fixed to a crossbeam 11 above the stage. As a matter of course, the lighting system can comprise a much higher number of light sources in such a case. In television studios or on studio stages, lighting systems can often comprise several thousand light sources. The representation of the stage 01 with the light sources 07 to 10 should only be understood as an example.

The stage set on the stage 01 can be recorded by means of two video cameras 12 and 13. The angle of view of the two video cameras 12 and 13 is indicated in FIG. 1 by dashed lines.

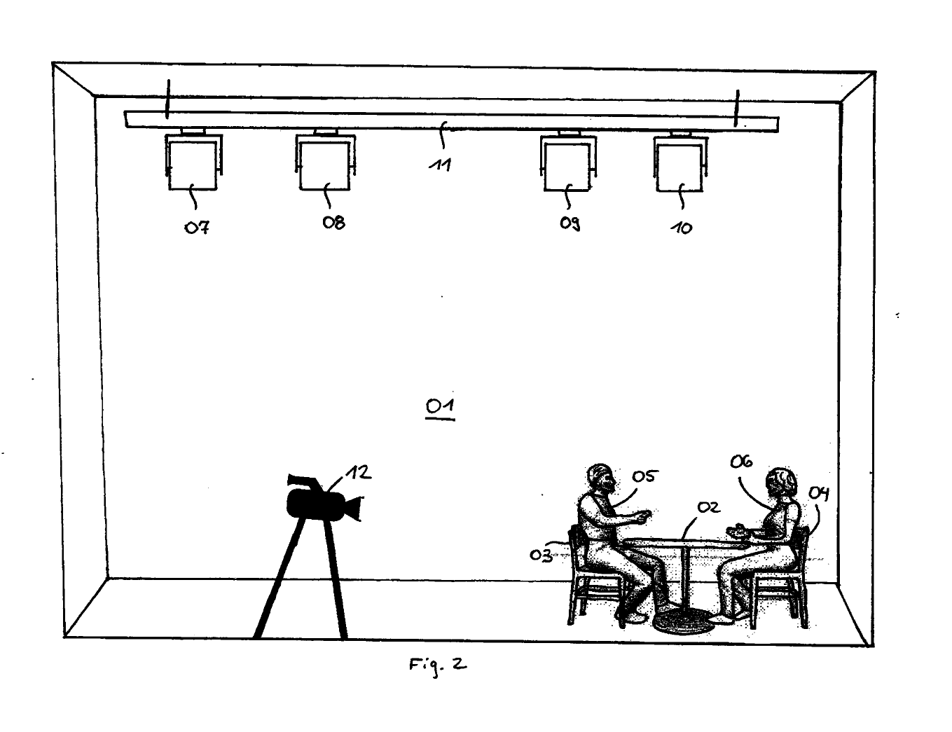

FIG. 2 shows the video image recorded by the video camera 13 with the table 02, the chairs 03 and 04, the actors 05 and 06, the light sources 07 to 10 and the crossbeam 11. It can be seen that the video camera 13 records the stage 01 in the wide shot. In front of the stage 01, the video camera 12, which is located in the selected image portion, is also recorded by the video camera 13.

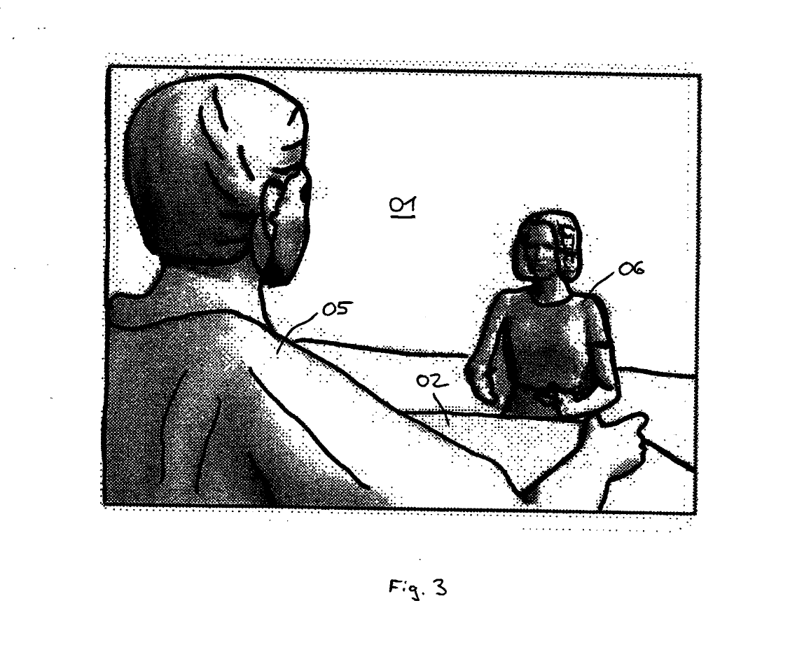

FIG. 3 shows the video image recorded by the video camera 12. In the selected angle of view, the image portion of the video camera 12 shows the actors 05 and 06 and a portion of the table 02.

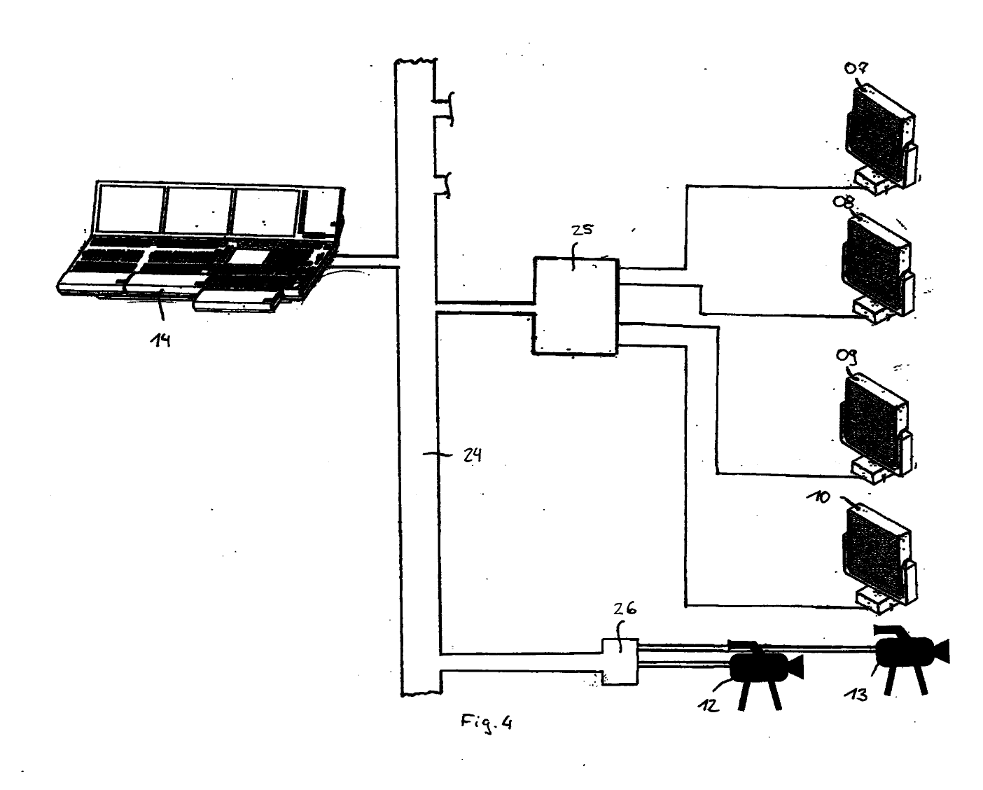

FIG. 4 shows the schematized structure of the lighting system for lighting the stage 01. For controlling the lighting system, a lighting control console 14 is provided, whose control commands are transmitted to DMX conversion nodes 25 via a data network 15. In FIG. 4, merely by way of example, only one DMX conversion node 25 is illustrated. In real lighting systems, a plurality of DMX conversion nodes 25 can be connected to the data network 15. Within the DMX conversion node 25, the digital control commands of the lighting control console are converted into DMX control commands and are transmitted to the light sources 07 to 10 which are connected to the DMX conversion node 25. As a result, the user can thus operate the light sources 07 to 10 in a program-controlled way by operating the lighting control console 14.

Furthermore, a video conversion device 26, which also forms a network node, is connected to the data network 24. The two video cameras 12 and 13 are connected to said video conversion device 26. The video signals of the video cameras 12 and 13 are transmitted to the video conversion device 26 and there are converted into digital image data signals, which can be processed by the digital processor of the lighting control console. Subsequently, the digital image data signals are transmitted to the digital processor in the lighting control console 14 via the data network 24.

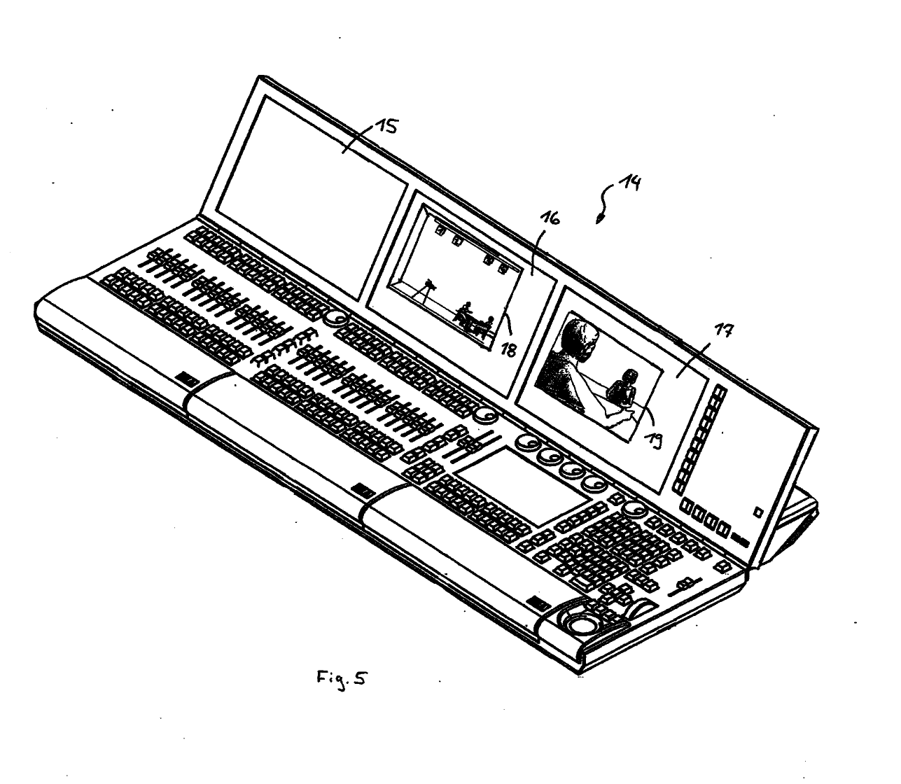

FIG. 5 shows the lighting control console 14 after transmission of the digital image signals for representing the stage 01 in the angle of view of the video cameras 12 and 13. The lighting control console 14 comprises three displays 15, 16 and 17, at which image data can be visually displayed to the user. The displays 15, 16 and 17 are formed in the manner of touch screens, such that operating commands can also be entered by touching the displays 15, 16 and 17 at the lighting control console 14. After having been converted within the digital processor of the lighting control console 14, the images from the video camera 12 are processed in such a way that they can be displayed in a stage representation window 18. In the illustrated example, the stage representation window 18 is shown at the display 16, wherein the stage representation window 18 only takes up a portion of the screen of the display 16. The remaining areas of the display 16 can still be used for other applications of the lighting control console. For the image data from the video camera 13, a second stage representation window 19 is generated after conversion within the digital processor of the lighting control console 14. The stage representation window 19 is displayed on a portion of the screen of the display 17 in the illustrated example. The stage representation windows 18 and 19 are each based on their own display tasks and can arbitrarily be shown or hidden. Furthermore, the size of the stage representation window 18 and 19 can arbitrarily be changed.

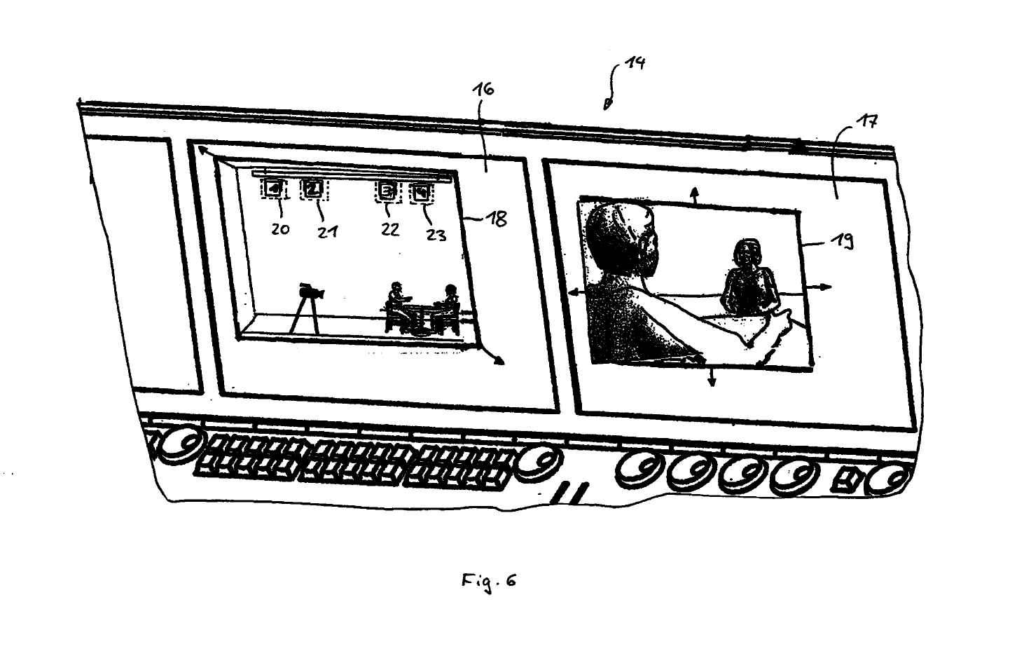

FIG. 6 shows the lighting control console 14 with the displays 16 and 17 and the stage representation windows 18 and 19 in an enlarged view. Due to being touch screens, the displays 16 and 17 make it possible for the user to move the stage representation windows 18 and 19 on the screen of the display 16 and 17 by touching and to change their size by means of multitouch inputs.

It is furthermore envisaged for the display task displayed in the stage representation window 18, that an image analysis task is carried out. In this image analysis, the light sources 07 to 10 are turned on one after the other for a short time, respectively, and the image data recorded in the process by the video camera 13 are analyzed in the digital processor of the lighting control console. Due to this image analysis, it is possible to identify the position of the individual light sources when shown in the stage representation window 18. In the illustrated example, the light source 07, for instance, has the designation “1”, whereas the light sources 08, 09 and 10 are named “2”, “3” and “4”. As a matter of course, other types of designations, for instance spotlight 1, spotlight 2, spotlight 3 or spotlight 4, are also conceivable here. After identifying the position of the light sources in the displayed image portion, the corresponding designations can be shown in the representation window 18 by means of the lighting control console, being assigned to the individual light sources 07 to 10 automatically and being correctly positioned.

Furthermore, by identifying the position of the light sources 07 to 10 within the stage representation window 18, it becomes possible that touch-sensitive portions 20, 21, 22 and 23 are defined on the touch-sensitive surface of the display 16 which is formed as a touch screen. If the user touches the touch-sensitive surface of the display 16 in the area of the touch-sensitive portions 20, 21, 22 or 23, the input command which is subsequently entered is automatically assigned to one of the light sources 07 to 10 in the control of the lighting control console 14. Thus, the user has the possibility to control the light sources in an intuitive manner. In order to select an individual light source 07, 08, 09 or 10, he only has to touch the display in one of the portions 20 to 23. Selecting is facilitated for the user in an intuitive manner in that the light sources 07 to 10 are shown anyway in said portions 20 to 23.

Controlling the light sources 07 to 10 can additionally be improved in that the images displayed in the stage representation window 18 are analyzed by means of an image analysis. Due to the image analysis, it can for instance be detected that both actors 05 and 06 are leaving the stage. When both actors 05 and 06 have left the stage 01, it can automatically be triggered by the lighting control console 14 that all light sources 07 to 10 are turned off, such that lighting of the stage 01 is automatically turned down after both actors 05 and 06 have left the stage 01.

1. A method for operating a lighting system, wherein the lighting system includes at least one lighting control console for controlling the lighting system, wherein the lighting control console has at least one digital processor and at least one digital memory which are suitable for generating, managing and storing data, and at least one display on which image data can be visually displayed, the system further includes multiple light sources, which can respectively emit light, wherein the light sources can be actuated by the lighting control console by transmitting actuating commands, in order to be able to change the illumination on a stage, and at least one video camera which can record at least one portion of the stage and generate a digital video signal, said method comprising the steps of:
a) illuminating the stage with light from at least one light source;
b) recording images of at least a portion of the stage with the video camera and generating digital video signals of the recording;
c) transmitting the digital video signals to a video conversion device;
d) converting the video signals into digital image data signals which can be processed in the digital processor of the lighting control console;
e) transmitting the digital image data signals to the digital memory of the lighting control console;
f) starting a display task in the digital processor of the lighting control console in order to process the image data signals for displaying the same at the display of the lighting control console; and
g) graphically representing at least a portion of the stage by displaying the image data signals which have been processed in the digital processor at the display of the lighting control console.

2. The method according to claim 1, in which, when the image data signals are processed in the digital processor of the lighting control console, a stage representation window is defined, in which the representation of at least a portion of the stage is displayed, wherein the stage representation window is displayed in a portion of the screen of the display.

3. The method according to claim 2, in which by entering user commands, a position of the stage representation window on the display is changed.

4. The method according to claim 2, in which by entering user commands, at least one of a size and a scale of the stage representation window on the display is changed.

5. The method according to claim 1, in which the display is a touch screen, wherein the user commands for manipulating the stage representation window are entered by touching the touch screen.

6. The method according to claim 1, in which in the digital processor of the lighting control console, an image analysis task is started in order to evaluate the image data signals with respect to image content.

7. The method according to claim 6, in which
at least one light source is selected, and, by transmitting an actuating command to said at least one light source, emission of a light signal is caused;
the light signal emitted by the selected at least one light source is recorded with the video camera; and
in the image analysis task, the image data signals are evaluated with respect to the light signal of the selected at least one light source, wherein a position of the selected at least one light source is identified in the displayed image portion.

8. The method according to claim 7, in which the designation of the selected at least one light source is shown at the position of the selected at least one light source in the displayed image portion.

9. The method according to claim 7, in which, when an input command is entered by touching a portion of the touch screen at the position of the selected at least one light source, the input command is assigned to the selected at least one light source.

10. The method according to claim 7, in which depending on-the-analysis results of the image analysis task, actuating commands are generated in order to actuate at least one light source as a function of the image content.

11. The method according to claim 10, in which actuating commands are generated by the image analysis task depending on at least one of actor movements on the stage, color changes on the stage, and brightness changes on the stage.

12. The method according to claim 11, in which the video camera is an infrared camera, wherein actuating commands are generated by the image analysis task depending on brightness changes in the infrared range.

13. The method according to claim 1, in which the digital video signals are generated by the video camera in one of USB data format, SDI data format, and VGA data format.

14. The method according to claim 1, in which the lighting control console is connected to a data network for the purpose of data transmission, wherein the video conversion device forms a network node for converting the video signals into digital image data signals, and the digital image data signals are transmitted to the digital processor of the lighting control console via the data network after having been converted within the video conversion device.
